(19) United States
(12) Patent Application Publication
(10) Pub. No.: US 2016/0189159 A1
(43) Pub. Date: Jun. 30, 2016

(54) PEER LOCATION DETECTION TO DETERMINE AN IDENTITY OF A USER

(71) Applicant: EBAY NC., San Jose, CA (US)

(72) Inventors: Bryant Genepang Luk, Round Rock, TX (US); Robert He, Pflugerville, TX (US); Christopher Diebold O'Toole, Cedar Park, TX (US)

(21) Appl. No.: 14/585,119

(22) Filed: Dec. 29, 2014

(51) Int. Cl. G06Q 20/40; H04W 12/06; G06Q 20/32

(52) U.S. Cl. CPC G06Q 20/4014; G06Q 20/3224; H04W 12/06

(57) ABSTRACT

There are provided systems and methods for peer location detection to determine an identity of a user. A user may initiate a transaction request for approval at a merchant location that the merchant rarely or has never visited. The transaction request may be initiated with a communication device of the user or through a payment instrument where the user has the communication device while at the merchant's location. The user may choose to not share the user's location using the communication device, thus, a payment processing service may not utilize the user's location as additional fraud detection. However, another user associated with the user may choose to share the location of the other user, such as through the communication device or in another transaction or transaction request. The payment processing service may detect the location of the associated user to assess a risk of fraud.

### TECHNICAL FIELD

The present application generally relates to peer location detection to determine an identity of a user and more specifically to determining and/or verifying an identity of a first user through detection of a second user that commonly co-locates with the first user.

### BACKGROUND

Fraudulent transactions pose a large risk for both merchants and payment provider services, such as banks, credit card providers, and/or online payment account providers. In order to reduce risk from fraud, both merchants and payment provider services may institute various safeguards, such as identification requirements, Personal Identification Number (PIN) usage, and/or through analysis of transaction parameters (e.g., location of the transaction, price, and/or items purchased in the transaction). During some transactions, not all information about the user and/or the transaction may be available. Additionally, users may choose to hide certain information from constant retrieval by merchants and/or services in order to retain privacy. Thus, when attempting to determine whether a user is physically located at a merchant location where a transaction is occurring, the merchant and/or payment provider service may be unable to determine a location of the user. In such cases, the merchant and/or payment provider service may deny valid transactions. However, if the merchant and/or payment service provider chooses instead to authorize the transaction, the entities may be exposing themselves to additional risk without collecting and analyzing adequate user and/or transaction information.

### BRIEF DESCRIPTION OF THE DRAWINGS

FIG. 1 is a block diagram of a networked system suitable for implementing the processes described herein, according to an embodiment;

FIG. 2 is an exemplary environment showing multiple users at various merchant locations where detection of an associated user may be utilized to determine an identity of a user and fraud risk in a transaction, according to an embodiment;

FIG. 3 is an exemplary system environment having a payment provider server determining a validity of a transaction request initiated by a communication device based on a location of another user, according to an embodiment;

FIG. 4 is a flowchart of an exemplary process for peer location detection to determine an identity of a user, according to an embodiment; and

FIG. 5 is a block diagram of a computer system suitable for implementing one or more components in FIG. 1, according to an embodiment.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

Provided are methods that provide for peer location detection to determine an identity of a user. Systems suitable for practicing methods of the present disclosure are also provided.

A first user may initiate a transaction request with a merchant to complete a payment to the merchant. The transaction request may include at least an identification of the first user's payment instrument (e.g., a first user payment card/account identifier) and the merchant location. The transaction request may be generated by the user's communication device with the merchant and/or with a merchant device for the merchant. For example, the user's communication device may provide the merchant device with a payment instrument for a payment. The transaction request may be communicated to a service provider that may provide authentication of the transaction request. In various embodiments, the service provider may further provide payment services to the merchant, such as through bank account, credit/payment card processing, and/or a payment account services by the service provider and held by the first user. In such embodiments, the transaction request may further include a request for a payment to the merchant for at least one product, good, service, or other item, referred to collectively as “item” or “items,” using the first user's payment instrument. When available, the service provider may match a location for the first user to the merchant location in order to provide additional fraud risk protection. However, in the embodiments disclosed herein, the location of the first user may not be available to the service provider, such as the user electing not to share their location or location determining services being unavailable. For example, the location of the first user may be hidden in the transaction request. Moreover, a location module (e.g., a GPS module and system) of the first user's communication device may further hide or obscure the first user's location.

Thus, if the merchant constitute a merchant that the user has not previously interacted with or rarely interacts with (e.g., never or rarely purchases items from), the service provider may wish to determine whether the first user is the person initiating the transaction request at the merchant's location using the payment instrument of the first user. Thus, the service provider may execute a module having specialized hardware and/or software to determine an identity of the user initiating the transaction request at the merchant location. The service provider may access a transaction history for the first user using the payment instrument. The transaction history may include past payments, transactions, and/or monetary transfers by the first user, for example, using the payment instrument and/or other payment instruments. The transaction history may be previously or concurrently processed to determine other users associated with the first user. For example, a second user associated with the first user may correspond to a second user that frequently visits the same merchant locations as the first user at the same or similar time as the first user. Thus, the service provider may determine the second user is associated with the first user based on purchases by the two users at the same or similar merchant location (e.g., the same merchant location or two merchant locations in close proximity to each other, such as merchants at a mall food court) within the same temporal proximity to each other. The service provider may also determine that the first and second users are associated based on transactions with each other and/or monetary transfers between the two users. For example, the second user may transfer the first user money after the first user purchases lunch, groceries, event tickets, etc.

The service provider may have determined identification (e.g., name, identifier, etc.) for the second user previously and stored the identification with the first user's transaction history, or may determine the identification at the time of receiving the transaction request. Using the identification, the service provider may determine a location for the second user. The second user may not elect to hide their location information from the service provider. For example, the second user may share the location of the second user with the service provider using a communication device of the second user. In other embodiments, the service provider may utilize the identification to request the location of the second user from the communication device. The second user may also initiate a separate transaction request and may complete the transaction request. Thus, the second user may generate a second user transaction request or completed transaction, which may include the location of the second user shared by the second user. In further embodiments, the second user may elect to hide the location of the second user similarly to the first user. However, the second user may generate a transaction request or completed transaction using a payment instrument for the second user. Thus, a transaction processing module of the service provider may determine the location of the second user based on a location where the transaction request/completed transaction using the second user's payment instrument occurred. In various embodiments, a wireless beacon at the merchant location may connect with the second user's communication device, such as through Bluetooth Low Energy (BLE), LTE Direct, WiFi, near field, or other communication protocols, to determine the location of the second user.

The service provider may then determine a validity of the first user's transaction request based on the merchant location and the location of the second user. For example, if the second user's location and the merchant location match, there may be less of a fraud risk as the second user associated with the first user is determined to be located at the merchant location while the payment instrument of the first user is being used. Thus, the first user may be identified at the merchant location. However, if the second user's location is not the same or similar (e.g., within a certain proximity) to the merchant location, the transaction may be more likely to be fraudulent. A likelihood of fraud score may be determined based on how many users associated with the first user are nearby the merchant location where the first user's payment instrument is being used. The validity determination may be communicated to the merchant's device so that the merchant's device and/or a merchant/merchant employee utilizing the device may determine whether to proceed with the transaction. Where the service provider offers payment fulfillment services, the service provider may determine whether to process a payment for the transaction request based on the validity determination. The merchant and/or the service provider may request additional identification information where the validity determination shows signs of fraud.

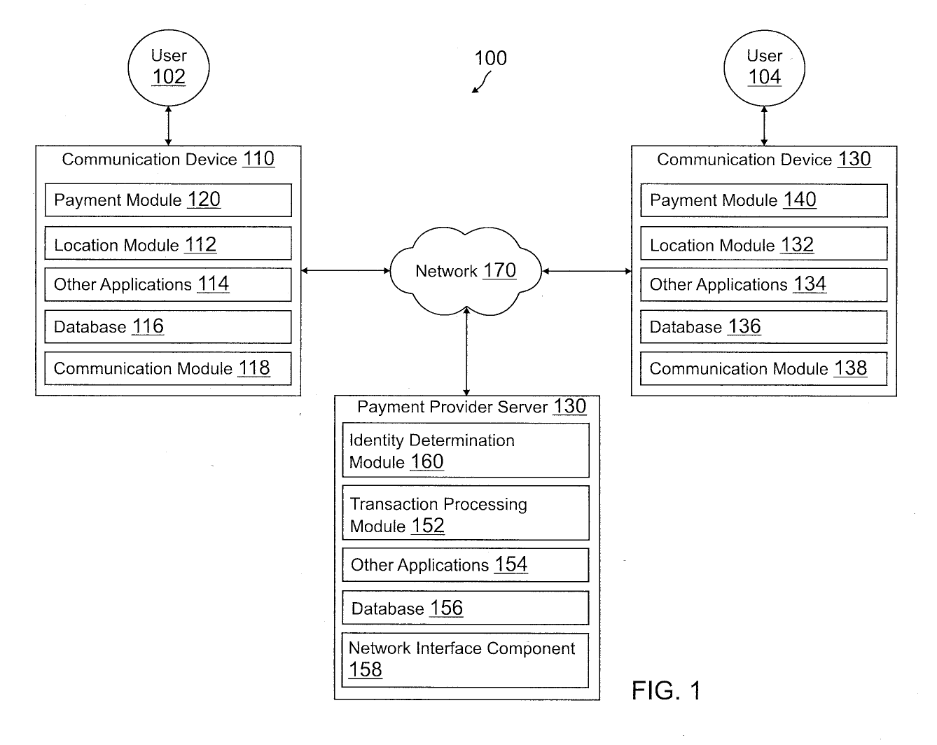

FIG. 1 is a block diagram of a networked system 100 suitable for implementing the processes described herein, according to an embodiment. As shown, system 100 may comprise or implement a plurality of devices, servers, and/or software components that operate to perform various methodologies in accordance with the described embodiments. Exemplary device and servers may include device, stand-alone, and enterprise-class servers, operating an OS such as a MICROSOFT® OS, a UNIX® OS, a LINUX® OS, or other suitable device and/or server based OS. It can be appreciated that the devices and/or servers illustrated in FIG. 1 may be deployed in other ways and that the operations performed and/or the services provided by such devices and/or servers may be combined or separated for a given embodiment and may be performed by a greater number or fewer number of devices and/or servers. One or more devices and/or servers may be operated and/or maintained by the same or different entities.

System 100 includes a user 102, a user 104, a communication device 110, a communication device 130, and a payment provider server 150 in communication over a network 170. A transaction request may be generated at a merchant location, for example, using communication device 110. The transaction request may include the merchant location and a payment instrument for use at the merchant location (e.g., to provide a payment in the transaction request to a merchant for the merchant location). The payment instrument may correspond to user 102 and may previously not have been used at the merchant location or is rarely used at the merchant location. Payment provider server 150 may determine user 104 is associated with user 102, such as based on a transaction history for user 102 accessed using the payment instrument. Payment provider server 150 may determine a location for user 102, such as through communication device 130. Payment provider server 150 may then determine the identity of the party initiating the transaction request at the merchant location.

Communication device 110, communication device 130, and payment provider server 150 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 100, and/or accessible over network 170.

Communication device 110 may be implemented as a communication device that may utilize appropriate hardware and software configured for wired and/or wireless communication with communication device 130, payment provider server 150, and/or other devices/service (e.g., a merchant device, a GPS service provider, a wireless beacon, or other device/server). For example, in one embodiment, communication device 110 may be implemented as a personal computer (PC), a smart phone, laptop/tablet computer, wristwatch with appropriate computer hardware resources, eyeglasses with appropriate computer hardware (e.g. GOOGLE GLASS®), other type of wearable computing device, and/or other types of computing devices capable of transmitting and/or receiving data, such as an IPAD® from APPLE®. Although a communication device is shown, the communication device may be managed or controlled by any suitable processing device. Although only one communication device is shown, a plurality of communication devices may function similarly.

Communication device 110 of FIG. 1 contains a payment module 120, a location module 112, other applications 114, a database 116, and a communication module 118. Payment module 120, location module 112, and other applications 114 may correspond to executable processes, procedures, and/or applications with associated hardware. In other embodiments, communication device 110 may include additional or different hardware and software as required.

Payment module 120 may correspond to one or more processes to execute modules and associated devices of communication device 110 to allow user 102 to enter payment options for storage by communication device 110, provide payment to a user/entity (e.g., a merchant corresponding to a generated transaction request) for one or more items, and complete a transaction for the item(s) using, in various embodiments, a payment instrument and/or payment provider server 150. In this regard, payment module 120 may correspond to specialized hardware and/or software utilized by communication device 110 to provide a convenient interface to permit user 102 to select payment options and provide payment to the merchant at a merchant location for one or more items. Thus, payment module 120 may be used, for example, to provide a convenient interface to permit user 102 to select payment options for payment instruments and provide payment for items and/or services. Such payment instruments may include bank accounts, payment cards (e.g., credit, debit, and/or gift cards), and/or a payment account with payment provider server 150. For example, payment module 120 may be implemented as an application having a user interface enabling the user to enter payment options for storage by communication device 110, provide payment to a merchant device at a merchant location for a merchant, and complete a transaction for the items and/or services using the aforementioned payment instrument (e.g., a payment account with payment provider server 150). In certain embodiments, payment module 120 may correspond more generally to a web browser configured to view information available over the Internet or access a website corresponding to a payment provider.

Payment module 120 may be utilized to initiate a transaction request at a merchant location for a merchant. However, in other embodiments, user 102 or payment module 120 may instead provide a payment instrument to a merchant device at the merchant location, where the merchant device generates the transaction request. In generating the transaction request, user 102 may enter a selection of items, such as through an input device of communication device 110 and/or through physically choosing the item(s) at the merchant location. The transaction request may include at least a payment instrument, such as a payment instrument proffered by user 102 to the merchant utilizing the merchant device and/or selected by user 102 using payment module 120. The merchant device and/or payment module 120 may include identification of at least the merchant location, such as through a merchant identifier, merchant location identifier, and/or location identifier.

Communication device 110 and/or the merchant device at the merchant location may communicate the transaction request to payment provider server 150 for verification that the payment instrument in the transaction request may be used at the merchant location and/or a determination of a risk of fraud if the payment instrument is used at the merchant location. However, when communicating the transaction request to payment provider server 150, payment module 120 and/or location module 112 may not share a location of user 102/communication device 110. For example, user 102 may elect to keep user 102's location and/or communication device 110's location hidden from at least the merchant device and payment provider server 150. Thus, payment provider server 150 may not have a location for user 102 and/or communication device 110. Thus, payment provider server 150 may verify the transaction request and/or use of the payment instrument at the merchant location using a location of user 104 associated with user 102, as discussed herein.

If payment provider server 150 determines that the payment instrument in the transaction request may be utilized at the merchant location in the transaction request based on the location of user 104, payment module 120 may be utilized to process and complete the transaction, for example, by authorizing the transaction with the merchant device at the merchant location and/or payment provider server 150 and receiving a payment history payment of an amount for the transaction history to the merchant for the merchant location. However, if payment provider server 150 does not verify/validate the transaction request based on the location of user 104, user 102 may provide additional information in order to authorize the transaction. For example, user 102 may utilize payment module 120 and/or location module 112 to provide a location for user 102 and/or communication device 110. User 102 may also utilize payment module 120 to provide additional verification, such as a social security number, PIN, account password, or other information.

Location module 112 may correspond to one or more processes to execute modules and associated devices of communication device 110 to determine a location for user 102, for example, through a GPS or mapping module and/or through establishing a connection with one or more of wireless beacons established at a location including at or nearby a merchant location. In this regard, location module 112 may correspond to specialized hardware and/or software utilized by communication device 110 to determine the location of user 102. For example, in certain embodiments, location module 112 may include a GPS module that may interface with a GPS service in order to determine a location for user 102, such as latitude and/or longitude coordinate values. Location module 112 may also include a mapping module that may determine a location for user 102 based on location entries by user 102, connections with one or more nearby locations to user 102, and/or check-in with such location. Location module 112 may further determine a travel route for user 102 based on user 102's entries (e.g., a start point and/or end point), a calendar/schedule for user 102, and/or a location for user 102 and a merchant store where user 102 may make a payment request.

In various other embodiments, location module 112 receives short range wireless communications from one or more of wireless beacons through communication module 118 and transmits information to the wireless beacons, including check-in information for a check-in process that associates user 102 with the wireless beacons connected with communication device 110. For example, a wireless beacon may be located at or nearby a merchant location and set up to communicate with communication device 110 when communication device 110 is in proximity to the wireless beacon. The wireless beacon may be range limited to connect only with devices (e.g., communication device 110) within the specified area, such as a radius around the wireless beacon, a distance away from the wireless beacon, and/or a signal direction for the wireless beacon. When communication device 110 enters the proximity radius for one or more of wireless beacons, communication device 110 and the wireless beacon may connect and check-in information including an identifier for user 102 and/or communication device 110 may be transmitted to the connected wireless beacon.

Location module 112 may execute in the background of an operating system of communication device 110 and be configured to establish connections, using communication module 118 of communication device 110, with one or more of wireless beacons. The connection may be established with or without user input from user 102. For example, wireless beacons may broadcast a token, such as a universally unique identifier (UUID), for reception by location module 112, as will be explained in more detail herein. Location module 112 may utilize communication module 118 of communication device 110 to receive the token from a wireless beacons. If location module 112 acknowledges the UUID as identifying the merchant location and/or the wireless beacon, (e.g., if location module 112 determines the UUID corresponds to a request to establish a communication channel and/or process and complete a check-in), location module 112 may transmit an identifier corresponding to user 102 and/or communication device 110 back to the wireless beacon. Location module 112 may utilize communication module 118 of communication device 110 to communicate with the wireless beacon (e.g., over near field communication, Bluetooth, Bluetooth Low Energy, radio, infrared, LTE Direct, or other communication protocol). The identifier from communication device 110 may include, be transmitted with, concatenated with, or otherwise bundled with the identifier received from the wireless beacon. Thus, the wireless beacon may identify the communication as associated with a connection request by the wireless beacon. In other embodiments, different information may be transmitted to the wireless beacon, such as an identifier for user 102, a name or other personal information for user 102, or other identifying information. Thus, the information transmitted to the wireless beacon does not need to be utilized to process and/or complete a check-in in all embodiments. Once a connection is established with a wireless beacon, the process may associate user 102 with the wireless beacon used to connect to communication device 110.

Location module 112 may be utilized to provide a location to payment module 120 as well as transmit a location for user 102 to a merchant device and/or payment provider server 150. Additionally, user 102 may utilize one or more interfaces of payment application 120 and/or location module 112 to prevent sharing of a location determined by location module 112. Thus, as discussed herein, although location module 112 may be used to determine a location of user 102 and/or communication device 110, user 102 may prevent sharing of the location of user 102 and/or communication device 110, for example, with a transaction request and/or for processing of a payment to a merchant. Thus, payment provider server 150 may determine a location of user 104 for use in determining an identity of a user (e.g., user 102) utilizing a payment instrument provided by the user and/or payment module 120.

In various embodiments, one or more features of location module 112 and/or payment module 120 may be incorporated in the same module so as to provide their respective features in specialized hardware and/or software of one module.

In various embodiments, communication device 110 includes other applications 114 as may be desired in particular embodiments to provide features to communication device 110. For example, other applications 114 may include security applications for implementing client-side security features, programmatic client applications for interfacing with appropriate application programming interfaces (APIs) over network 170, or other types of applications. Other applications 114 may also include email, texting, voice and IM applications that allow a user to send and receive emails, calls, texts, and other notifications through network 170. In various embodiments, other applications 114 may include financial applications, such as banking, online payments, money transfer, or other applications associated with a payment provider. As previously discussed, other applications may include mapping, travel, calendaring/scheduling, Internet browser applications, or other applications, which, for example, may be utilized to determine a location of user 102. Other applications 114 may include device interfaces and other display modules that may receive input from user 102 and/or output information to user 102. For example, other applications 114 may contain software programs, executable by a processor, including a graphical user interface (GUI) configured to provide an interface to the user.

Communication device 110 may further include database 116 stored to a transitory and/or non-transitory memory of communication device 110, which may store various applications and data and be utilized during execution of various modules of communication device 110. Thus, database 116 may include, for example, identifiers such as operating system registry entries, cookies associated with payment module 120, location module 112, and/or other applications 114, identifiers associated with hardware of communication device 110, or other appropriate identifiers, such as identifiers used for payment/user/device authentication or identification. Database 116 may include payment instruments for user 102, such as credit/debit/gift cards, bank accounts, and/or payment accounts with payment provider server 150. Additionally, location information for user 102 and/or communication device 110 may be stored to database 116. However, such location information may not be transmitted by communication module 118 to other entities, such as a merchant device and/or payment provider server 150, for example, with a transaction request or while processing the transaction request. Database 116 may also store information for use in the transaction request, such as a merchant identifier, a merchant location, a merchant location identifier, an amount to pay a merchant associated with the merchant location, items and item information for the transaction request, and/or payment information to provide payment to the merchant. However, in embodiments where the merchant's device generates the transaction request, database 116 may not store such information, which may instead be retained by the merchant device.

Communication device 110 includes at least one communication module 118 adapted to communicate with one or more wireless beacons, a merchant device communication device 130, and/or payment provider server 150. In various embodiments, communication module 118 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices. Communication module 118 may communicate directly with one or more wireless beacons using short range communications, such as Bluetooth Low Energy, LTE Direct, WiFi, radio frequency, infrared, Bluetooth, and near field communications.

Communication device 130 may be implemented as a communication device that may utilize appropriate hardware and software configured for wired and/or wireless communication with communication device 110, payment provider server 150, and/or other devices/service (e.g., a merchant device, a GPS service provider, a wireless beacon, or other device/server used to determine a location for user 104 and communicate the location to payment provider server 150 for processing). For example, in one embodiment, communication device 130 may be implemented as a personal computer (PC), a smart phone, laptop/tablet computer, wristwatch with appropriate computer hardware resources, eyeglasses with appropriate computer hardware (e.g. GOOGLE GLASS®), other type of wearable computing device, and/or other types of computing devices capable of transmitting and/or receiving data, such as an IPAD® from APPLE®. Although a communication device is shown, the communication device may be managed or controlled by any suitable processing device. Although only one communication device is shown, a plurality of communication devices may function similarly.

Communication device 130 of FIG. 1 contains a payment module 140, a location module 132, other applications 134, a database 136, and a communication module 138. Payment module 140, location module 132, and other applications 134 may correspond to executable processes, procedures, and/or applications with associated hardware. In other embodiments, communication device 130 may include additional or different hardware and software as required.

Payment module 140 may correspond to one or more processes to execute modules and associated devices of communication device 130 to allow user 104 to enter payment options for storage by communication device 130, provide payment to a user/entity (e.g., a merchant corresponding to a generated transaction request by user 104 with the merchant where user 104 shares their location with the merchant and/or payment provider server 150) for one or more items, and complete a transaction for the item(s) using, in various embodiments, a payment instrument for user 102 and/or payment provider server 150. In this regard, payment module 140 may correspond to specialized hardware and/or software utilized by communication device 130 to provide a convenient interface to permit user 104 to select payment options and provide payment to the merchant at a merchant location for one or more items. Thus, payment module 140 may be used, for example, to provide a convenient interface to permit user 102 to select payment options for payment instruments of user 104 and provide payment for items and/or services. Such payment instruments may include bank accounts, payment cards (e.g., credit, debit, and/or gift cards), and/or a payment account with payment provider server 150. For example, payment module 140 may be implemented as an application having a user interface enabling the user to enter payment options for storage by communication device 130, provide payment to a merchant device at the merchant location for the merchant, and complete a transaction for the items and/or services using the aforementioned payment instrument (e.g., a payment account with payment provider server 150). In certain embodiments, payment module 140 may correspond more generally to a web browser configured to view information available over the Internet or access a website corresponding to a payment provider.

Payment module 140 may be utilized to initiate a transaction request at a merchant location for a merchant and complete the transaction request, for example, by providing a payment instrument for user 104 and/or a location for user 104 while at the merchant location. However, in other embodiments, user 104 or payment module 140 may instead provide the payment instrument for user 104 to a merchant device at the merchant location, where the merchant device generates the transaction request. In generating the transaction request, user 104 may enter a selection of items, such as through an input device of communication device 130 and/or through physically choosing the item(s) at the merchant location. The transaction request may include at least a payment instrument for user 104, such as a payment instrument proffered by user 102 to the merchant utilizing the merchant device and/or selected by user 102 using payment module 140. The merchant device and/or payment module 140 may include identification of at least the merchant location, such as through a merchant identifier, merchant location identifier, and/or location identifier.

Additionally, in various embodiments, the transaction request for user 104 with the merchant may include a location for user 104. However, in other embodiments, the transaction request may instead identify user 104 through the payment instrument provided by user 104, where payment provider server 150 identifier the location of user 104 using the payment instrument for user 104 and the merchant location. Communication device 130 and/or the merchant device at the merchant location may communicate the transaction request to payment provider server 150 for processing and completion of a payment to the merchant associated with the merchant location in the transaction request. Moreover, payment provider server 150 may utilize the transaction request, the completed transaction (e.g., the payment to the merchant) associated with the transaction request, and/or the location provided in the transaction request or completed transaction to determine a location for user 104. User 104 may then match the location to the merchant location to determine a validity of a transaction request having a payment instrument associated with user 102 and/or communication device 110, as discussed herein. In various other embodiments, payment provider server 150 may determine a location of user 104 through location module 132, such as from receipt of a location of user 104 from location module 132 or through a request for the location of user 104 from location module 132.

Location module 132 may correspond to one or more processes to execute modules and associated devices of communication device 130 to determine a location for user 104, for example, through a GPS or mapping module and/or through establishing a connection with one or more of wireless beacons established at a location including at or nearby a merchant location. In this regard, location module 132 may correspond to specialized hardware and/or software utilized by communication device 130 to determine the location of user 104. For example, in certain embodiments, location module 132 may include a GPS module that may interface with a GPS service in order to determine a location for user 104, such as latitude and/or longitude coordinate values. Location module 132 may also include a mapping module that may determine a location for user 104 based on location entries by user 104, connections with one or more nearby locations to user 104, and/or check-in with such location. Location module 132 may further determine a travel route for user 104 based on user 104's entries (e.g., a start point and/or end point), a calendar/schedule for user 104, and/or a location for user 104 and a merchant location where user 104 may make a payment request.

In various other embodiments, location module 132 receives short range wireless communications from one or more of wireless beacons through communication module 138 and transmits information to the wireless beacons, including check-in information for a check-in process that associates user 104 with the wireless beacons connected with communication device 130. For example, a wireless beacon may be located at or nearby a merchant location and set up to communicate with communication device 130 when communication device 130 is in proximity to the wireless beacon. The wireless beacon may be range limited to connect only with devices (e.g., communication device 130) within the specified area, such as a radius around the wireless beacon, a distance away from the wireless beacon, and/or a signal direction for the wireless beacon. When communication device 130 enters the proximity radius for one or more of wireless beacons, communication device 130 and the wireless beacon may connect and check-in information including an identifier for user 104 and/or communication device 130 may be transmitted to the connected wireless beacon.

Location module 132 may execute in the background of an operating system of communication device 130 and be configured to establish connections, using communication module 138 of communication device 130, with one or more of wireless beacons. The connection may be established with or without user input from user 104. For example, wireless beacons may broadcast a token, such as a universally unique identifier (UUID), for reception by location module 132, as will be explained in more detail herein. Location module 132 may utilize communication module 138 of communication device 130 to receive the token from a wireless beacons. If location module 132 acknowledges the UUID as identifying the merchant location and/or the wireless beacon, (e.g., if location module 132 determines the UUID corresponds to a request to establish a communication channel and/or process and complete a check-in), location module 132 may transmit an identifier corresponding to user 104 and/or communication device 130 back to the wireless beacon. Location module 132 may utilize communication module 138 of communication device 130 to communicate with the wireless beacon (e.g., over near field communication, Bluetooth, Bluetooth Low Energy, radio, infrared, LTE Direct, or other communication protocol). The identifier from communication device 130 may include, be transmitted with, concatenated with, or otherwise bundled with the identifier received from the wireless beacon. Thus, the wireless beacon may identify the communication as associated with a connection request by the wireless beacon. In other embodiments, different information may be transmitted to the wireless beacon, such as an identifier for user 104, a name or other personal information for user 104, or other identifying information. Thus, the information transmitted to the wireless beacon does not need to be utilized to process and/or complete a check-in in all embodiments. Once a connection is established with a wireless beacon, the process may associate user 104 with the wireless beacon used to connect to communication device 130.

Location module 112 may be utilized to provide a location to payment module 120 as well as transmit a location for user 102 to a merchant device and/or payment provider server 150. Although user 104 may elect to hide user 104's location using one or more of payment module 140 and location module 132, user 104 may instead have elected to share their location. Thus, payment provider server 150 may receive the location of user 104 using a location determined by location module 132 and/or through information provided in a transaction request initiated by user 104 (e.g., using payment module 140). Additionally, in the event where user 104 chooses to hide the location of user 104 or the location is otherwise unavailable to the payment provider, payment provider server 150 may determine a location of user 104 through a payment instrument in a transaction request coupled with the merchant location in the transaction request.

In various embodiments, one or more features of location module 132 and/or payment module 140 may be incorporated in the same module so as to provide their respective features in specialized hardware and/or software of one module.

In various embodiments, communication device 130 includes other applications 134 as may be desired in particular embodiments to provide features to communication device 130. For example, other applications 134 may include security applications for implementing client-side security features, programmatic client applications for interfacing with appropriate application programming interfaces (APIs) over network 170, or other types of applications. Other applications 134 may also include email, texting, voice and IM applications that allow a user to send and receive emails, calls, texts, and other notifications through network 170. In various embodiments, other applications 134 may include financial applications, such as banking, online payments, money transfer, or other applications associated with a payment provider. As previously discussed, other applications may include mapping, travel, calendaring/scheduling, Internet browser applications, or other applications, which, for example, may be utilized to determine a location of user 104. Other applications 134 may include device interfaces and other display modules that may receive input from user 104 and/or output information to user 104. For example, other applications 134 may contain software programs, executable by a processor, including a graphical user interface (GUI) configured to provide an interface to the use.

Communication device 130 may further include database 136 stored to a transitory and/or non-transitory memory of communication device 130, which may store various applications and data and be utilized during execution of various modules of communication device 130. Thus, database 136 may include, for example, identifiers such as operating system registry entries, cookies associated with payment module 140, location module 132, and/or other applications 134, identifiers associated with hardware of communication device 130, or other appropriate identifiers, such as identifiers used for payment/user/device authentication or identification. Database 136 may include payment instruments for user 102, such as credit/debit/gift cards, bank accounts, and/or payment accounts with payment provider server 150. Additionally, location information for user 104 and/or communication device 130 may be stored to database 136.

Communication device 130 includes at least one communication module 138 adapted to communicate with one or more wireless beacons, a merchant device communication device 110, and/or payment provider server 150. In various embodiments, communication module 138 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices. Communication module 138 may communicate directly with one or more wireless beacons using short range communications, such as Bluetooth Low Energy, LTE Direct, WiFi, radio frequency, infrared, Bluetooth, and near field communications.

Payment provider server 150 may be maintained, for example, by an online payment service provider, which may provide validation of a transaction request having a payment instrument for user 102 based on a location of user 104. Additionally, payment provider server 150 may be utilized to process a transaction with a merchant. In this regard, payment provider server 150 includes one or more processing applications which may be configured to interact with communication device 110, communication device 130, and/or a merchant device to facilitate payment for a transaction (e.g., a sale offer for an event admission ticket). In one example, payment provider server 150 may be provided by PAYPAL®, Inc. of San Jose, Calif., USA. However, in other embodiments, payment provider server 150 may be maintained by or include a credit provider, financial services provider, financial data provider, and/or other service provider, which may provide payment services to user 102, user 104, and/or a merchant.

Payment provider server 150 of FIG. 1 includes an identity determination module 160, a transaction processing module 152, other application 154, a database 156, and a network interface component 158. Identity determination module 160, transaction processing module 152, and other applications 154 may correspond to executable processes, procedures, and/or applications with associated hardware. In other embodiments, payment provider server 150 may include additional or different hardware and software as required.

Identity determination module 160 may correspond to one or more processes to execute modules and associated specialized hardware of payment provider server 150 to determine a validity of a transaction request at a merchant location for one or more of user 102's payment instruments based on a location of user 104 and communicate the validity to one or more of communication device 110, a merchant device, and transaction processing module 152. In this regard, transaction processing module 152 may correspond to specialized hardware and/or software to receive and/or access a transaction request from communication device 110 and/or a merchant device, where the transaction request includes at least identification of a merchant location and a payment instrument for user 102. If user 102's payment instrument has never or is rarely used at the merchant location, identity determination module 160 may determine an identity of the party using the payment instrument at the merchant location. However, if user 102 elects to not share user 102's location through communication device 110 or the location of user 102 is otherwise unavailable to the payment provider, identity determination module 160 may validate the identity of user 102 at the merchant location by determining the location of user 104.

Thus, identity determination module may access a transaction history for user 102 using the received payment instrument. The transaction history may be for the specific payment instrument received, or may be for user 102 in general. Using the transaction history, an identity of user 104 may be determined. For example, transaction history may include past payments, transactions, and/or monetary transfers by the first user, for example, using the payment instrument and/or other payment instruments. The transaction history may be previously or concurrently processed to determine other users associated with the first user. The identity (e.g., an identifier) for user 104 may be stored with the transaction history based on previous processing of the transaction history. In other embodiments, identity determination module 160 may determine the identity of user 104 when determining the validity of the transaction request. User 104 may correspond to a user associated with user 102 based on previous transaction, payments, and/or transfers in the transaction history. For example, user 102 and user 104 may frequently visit the same merchant locations at the same or similar time as shown based on similar payment in user 102's and user 104's respective transaction histories. Thus, identity determination module 160 may determine user 104's identity based on purchases by the two users at the same or similar merchant location (e.g., the same merchant location or two merchant locations in close proximity to each other, such as merchant's at a mall food court) within the same temporal proximity to each other. Identity determination module 160 may also determine user 102 and user 104 are associated based on transactions with each other and/or monetary transfers between the two users. For example, user 102/user 104 may transfer the other user money (e.g., for a lunch, groceries, event tickets, etc.). Identity of user 104 may also be determined using other information that indicates user 104 is expected or is likely to be with user 102. For example, data from social networks, calendars, and the like may indicate that user 102 is expected or regularly is with user 104 at a certain location at a certain time.

Once user 104 is identified, a location for user 104 may be determined. The location for user 104 may be determined based on received information in user 104's transaction request and/or completed transaction (e.g., a location of user 104 and/or a merchant location). Identity determination module 160 may also determine the location of user 104 through communication device 130, for example, through received and/or request location information. Once user 104's location is determined, identity determination module 160 may match user 104's location to the merchant location in user 102's transaction request. Identity determination module 160 may also determine the location(s) of additional user(s) associated with user 102 based on user 102's transaction history in order to determine whether the location(s) of any of the additional user(s) match the merchant location in user 102's transaction request.

If user 104's location (and/or the additional user's location(s)) match the merchant location in user 102's transaction request (e.g., are located at the same or similar location), than identity determination module may validate user 102's transaction request by validating/verifying the identity of user 102 at the merchant location. Thus, the merchant and/or payment provider server 150 may process a payment using the payment instrument. However, if user 104's location (and/or the additional user's location(s)) do not match the merchant location, identity determination module 160 may not validate the transaction request. For example, identity determination module 160 may generate a communication to one or more of communication device 110 and the merchant device that alerts user 102 and/or the merchant of the potentially fraudulent transaction. Identity determination module 160 may also determine a likelihood of fraud score based on user 104's location (and/or the additional user's location(s)) and the merchant location (e.g., a number of associated users at the merchant location and/or a distance between the user(s) location and the merchant location). The merchant and/or the merchant device may then request additional identification information from the user at the merchant device initiating the transaction request prior to validation of the transaction request.

Transaction processing module 152 may correspond to one or more processes to execute modules and associated specialized hardware of payment provider server 150 to receive and/or transmit information from communication device 110, communication device 130, and/or a merchant device for processing and completion of financial transactions, such as payments for a transaction request by user 102/user 104. In this regard, transaction processing module 152 may correspond to specialized hardware and/or software to process financial transaction information from communication device 110, communication device 130, and/or the merchant device by receiving a transaction request for payment of sale offer for an event admission ticket. The transaction request may correspond to a payment request from a user (including, in various embodiments, user 102/user 104) to a merchant associated with the merchant device at a merchant location. The payment request may be encrypted prior to transmission to transaction processing application 152. The payment request may include information corresponding to user identifiers, user financial information/identifiers, transaction information and/or identifiers, and/or merchant identifiers. Additionally, the payment request may include a payment amount and terms of payment for the sale offer. Once received, transaction processing module 152 may utilize a payment account or financial information of the paying user to render payment for the transaction request. Thus, transaction processing module 152 may be utilized to process a payment for a transaction request for user 102's payment instrument if the transaction request and/or identity of user 102 is validated by identity determination module 160, as discussed herein. Additionally, transaction processing module 152 may provide transaction histories, including receipts, to communication device 110, communication device 130, and/or payment provider server 150 for completion and documentation of the financial transaction for the sale offer.

In various embodiments, payment provider server 150 includes other applications 154 as may be desired in particular embodiments to provide features to payment provider server 150. For example, other applications 154 may include security applications for implementing server-side security features, programmatic server applications for interfacing with appropriate application programming interfaces (APIs) over network 170, or other types of applications. Other applications 154 may contain software programs, executable by a processor, including a graphical user interface (GUI), configured to provide an interface to a user.

Additionally, payment provider server 150 includes database 156. As previously discussed, user 102, user 104, and/or the merchant corresponding to merchant device 130 may establish one or more payment accounts with payment provider server 150. User accounts in database 156 may include user/merchant information, such as name, address, birthdate, payment/funding information, additional user financial information, and/or other desired user data. User 102, user 104, and/or the merchant may link to their respective payment accounts through a user, merchant, and/or device identifier. Thus, when an identifier is transmitted to payment provider server 150, e.g. from communication device 110, communication device 130, and/or a merchant device, an associated payment account may be found. In other embodiments, user 102, user 104, and/or the merchant may not have previously established a payment account and may provide other financial information to payment provider server 150 to complete financial transactions, as previously discussed. Database 156 may further include transaction histories for user 102 and/or user 104, include transaction histories for payment instrument(s) of user 102/user 104 that may be identified through the payment instrument(s). Database 156 may further include received transaction requests and processed transactions, such as completed transactions having payments to a merchant. Validity determinations of received transaction requests may also be stored to database 156.

In various embodiments, payment provider server 150 includes at least one network interface component 158 adapted to communicate communication device 110, communication device 130, and/or a merchant device over network 170. In various embodiments, network interface component 158 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

Network 170 may be implemented as a single network or a combination of multiple networks. For example, in various embodiments, network 170 may include the Internet or one or more intranets, landline networks, wireless networks, and/or other appropriate types of networks. Thus, network 170 may correspond to small scale communication networks, such as a private or local area network, or a larger scale network, such as a wide area network or the Internet, accessible by the various components of system 100.

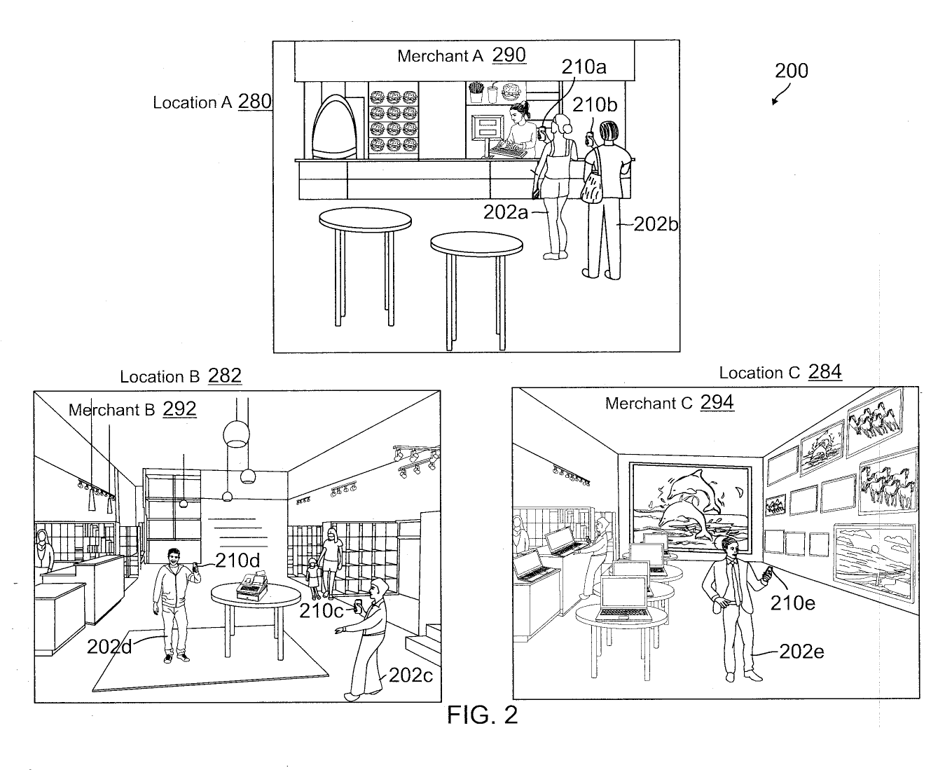

FIG. 2 is an exemplary environment showing multiple users at various merchant locations where detection of an associated user may be utilized to determine an identity of a user and fraud risk in a transaction, according to an embodiment. Environment 200 of FIG. 2 includes a user 202a having a communication device 210a, a user 202b having a communication device 210b, and a user 202c having a communication device 210c all corresponding generally to user 102 having communication device 110, respectively, of FIG. 1. Additionally, environment 200 includes a user 204a having a communication device 230a and a user 204b having a communication device 230b both corresponding generally to user 104 having communication device 130, respectively, of FIG. 1. In general, the number of users can be any number from two on up.

In environment 200, three different locations are associated with merchants where a user may visit to purchase items. Thus, a location A 280 includes a merchant A 290, a location B 282 includes a merchant B 292, and a location C 284 includes a merchant C 294. At location A 280, user 202a uses communication device 210a while initiating a transaction request with merchant A 290. For example, user 202a may utilize communication device 210a to provide a payment instrument to merchant A 290. However, user 202a may choose to not share the location of user 202a. Thus, a payment provider service may wish to validate the identity of user 202a at location A 280 and generating the transaction request with merchant A 290 having user 202a's payment instrument. The payment provider service may utilize a location of user 204a to validate the identity and transaction request of user 202a at location A 280. For example, user 204a may be associated with user 202a based on a transaction history of user 202a. Thus, using a location of user 204a, for example, determined using communication device 230a, the payment provider service may validate the identity of user 202a and user 202a's transaction request based on the location of the associated user 204a.

However, at location B 282, user 202b is utilizing communication device 210b to initiate a transaction request with merchant B 292, for example, by providing a payment instrument from communication device 210b (e.g., a payment account and/or a payment card/bank account). Similarly, the payment provider server may not have a location for the user associated with the payment instrument. In the embodiment shown in location B 282, user 202b may be a fraudulent user utilizing payment instruments on communication device 210b. Thus, as the payment provider service only detects user 202c with communication device 210c at location B 282, the payment provider service may determine that the transaction request initiated by user 202b using communication device 210b is suspicious and/or fraudulent. In addition, user 202b located at location C 284 and purchasing with merchant C 294 may be associated with the payment instrument provided by communication device 210b to merchant B 292. Therefore, as the payment provider server detects user 204b at location C 284 separate from location B 282 (e.g., through communication device 230c in possession of user 204c), the payment provider server may determine the transaction request initiated by user 202b is likely to be more fraudulent.

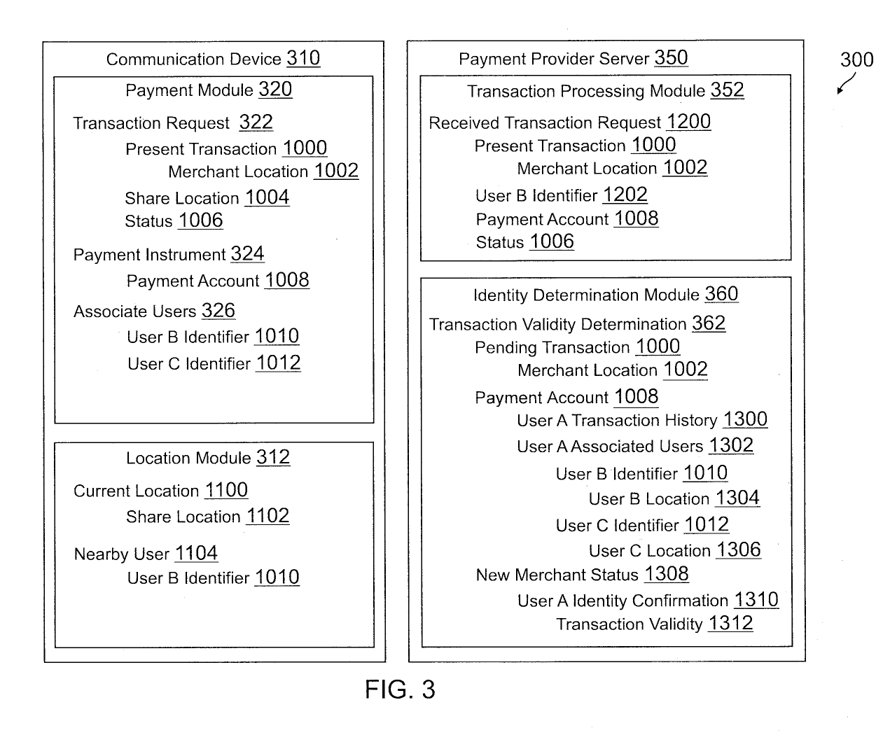

FIG. 3 is an exemplary system environment having a payment provider server determining a validity of a transaction request initiated by a communication device based on a location of another user, according to an embodiment. Environment 300 of FIG. 3 includes a communication device 310 and a payment provider server 350 corresponding generally to communication device 110 and payment provider server 150, respectively, of FIG. 1.

Communication device 310 executes a payment module 320 and a location module 312 corresponding generally to the specialized hardware and/or software modules and processes described in reference to payment module 120 and location module 112, respectively, of FIG. 1. In this regard, payment module 320 may be utilized to initiate a transaction request at a merchant location, for example, by generating the transaction request using an identifier for the merchant, merchant location, and/or merchant information or through transmitting a payment instrument to a merchant device at the merchant location. Thus, payment module 320 includes a transaction request 322, payment instruments 324, and associated users 326. Transaction request 322 may correspond to a generated transaction request with a merchant at a merchant location, and may include a pending transaction 1000 having a merchant location 1002, a share location 1004 option to share the location of communication device 310 with pending transaction 1000, and a status 1006 of pending transaction 1000. Additionally, the user (not shown) of communication device 310 may view the user's payment instruments and select a payment instrument for pending transaction 1000 under payment instruments 324 having payment account 1008 as the selected account. Moreover, the user may view and manage other users associated with the user, such as through a transaction history of the user, under associated users 326. Thus, associated users 326 include a user B identifier 1010 and a user C identifier 1012.

Communication device 310 further executes location module 312 to determine a location of communication device 310 and/or the user of communication device 310. In this regard, location module 312 includes a current location 1100 and an option to share current location 1100 under share location 1102, such as with payment provider server 350. The location may be shared during transaction request 322 using share location 1004 option as well. However, as discussed herein, the user may elect to not share the location, and thus, payment provider server 350 may determine the validity of transaction request 322 and/or identity of the user using a location of another user associated with the user, such as a user under associated users 326. Moreover, location module 312 includes nearby users 1104, such as user B identifier 1010, which may display when one or more of associated users 326 are nearby the user.

Payment provider server 350 executes a transaction processing module 352 and identity determination module 360 corresponding generally to the specialized hardware and/or software modules and processes described in reference to transaction processing module 152 and identity determination module 160, respectively, of FIG. 1. In this regard, transaction processing module 352 may be required to process a pending transaction/payment in a transaction request, such as pending transaction 1000 in transaction request 322. Transaction processing module 352 includes a received transaction request 1200 corresponding to at least some of the information from transaction request 322. Thus, received transaction request 1200 is shown with pending transaction 1000 having merchant location 1002, user A identifier 1202, which may be transmitted by communication device 310 in order to authenticate the user of communication device 310 (e.g., user A), payment account 1008 from payment instruments 324, and status 1006. In other embodiments, a merchant may process the transaction/payment and instead require payment provider server 352 to validate the transaction request and/or identity of the user initiating the transaction request.

In order to update status 1006 and proceed with the transaction, identity determination module 360 may be utilized to perform transaction validity determination 362. Transaction validity determination 362 may utilize received and/or accessed information to update status 1006. In this regard, transaction validity determination 362 includes pending transaction 1000 having merchant location 1002. Using payment account 1008 (and/or user A identifier 1202 in various embodiments), user A transaction history 1300 may be determined. Thus, user A associated users 1302 may be retrieved, for example based on user A transaction history 1300, as discussed herein. User A associated users 1302 may include user B identifier 1010 and user C identifier 1012 where user A associated users 1302 corresponds to associated users 326. Moreover, with user B identifier 1010, identity determination module 360 may access a user B location 1304. Similarly, using user C identifier 1012, identity determination module 360 may access a user C location 1306. Thus, if the merchant in merchant location 1002 comprises a new merchant status 1308, identity determination module 360 may perform a user A identity confirmation 1310 and determine a transaction validity 1312.

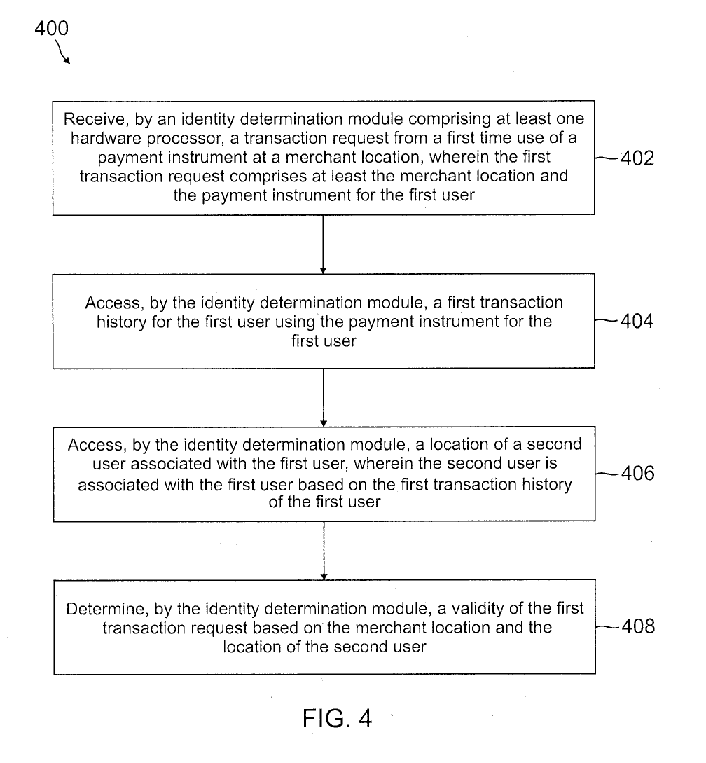

FIG. 4 is a flowchart of an exemplary process for peer location detection to determine an identity of a user, according to an embodiment. Note that one or more steps, processes, and methods described herein may be omitted, performed in a different sequence, or combined as desired or appropriate.

At step 402, a transaction request from a first time use of a payment instrument for a first user at a merchant location is received, by an identity determination module comprising at least one hardware processor, wherein the first transaction request comprises at least the merchant location and the payment instrument for the first user. In various embodiments, prior to receiving the transaction request, a second user may be determined using a transaction history of the first user. The transaction history for the first user is accessed, by the identity determination module, using the payment instrument for the first user, at step 404. The transaction history may comprise an identifier for the second user.

A location of a second user associated with the first user is accessed, by the identity determination module, wherein the second user is associated with the first user based on the first transaction history of the first user, at step 406. A communication device of the second user may determine the location of the second user using a location module and transmits the location of the second user to a network interface component associated with the identity determination module. The identity determination module may have requested the location of the second user from a communication device of the second user. In other embodiments, the second user may permit the location of the second user to be shared in one of a second transaction request for the second user and a completed transaction by the second user, wherein the network interface component receives the location of the second user with the one of the second transaction request and the completed transaction. One of the second transaction request and the completed transaction may be at the merchant location, thus identifying the second user at the merchant location.

In various embodiments, a transaction processing module may determine the location of the second user using one of the second transaction request and the completed transaction. Additionally, a merchant device at the merchant location may be connected to a wireless beacon using a short range communication protocol (e.g., one of near field communication, radio communication, infrared communication, Bluetooth communication, Bluetooth Low Energy (BLE) communication, LTE Direct communication, and WiFi communication). Thus, the wireless beacon may connect with the second user's communication device to determine the location of the second user.

At step 408, a validity of the transaction request is determined, by the identity determination module, based on the merchant location and the second user location of the second user. The validity may comprise an identification of the first user at the merchant location if the location of the second user matches the merchant location. Thus, where the transaction request comprises a payment to a merchant associated with the merchant location using the payment instrument, a transaction processing module may process the payment to the merchant using the payment instrument based on the identification of the first user at the merchant location to generate a payment history for the payment to the merchant. In such embodiments, the validity of the transaction request comprises determining the identity of the first user at the merchant location by determining the second user location of the second user matches the merchant location.

However, the validity may also comprise a notification that the first transaction request is invalid if the location of the second user does not match the merchant location or may comprise a notification that the first transaction request is suspicious if the location of the second user does not match the merchant location. Thus, at least one of a merchant device and a merchant associated with the merchant device request additional identification from the first user for processing of the first transaction request based on the notification. Additionally, a third user location of a third user associated with the first user may be accessed, wherein the third user is associated with at least one of the first user and the second user based on at least one of the first transaction history of the first user and a second transaction history of the second user. The validity may be further determined using the third user location. In such embodiments, the validity comprises a likelihood of fraud score based on the second user location and the third user location matching the merchant location.

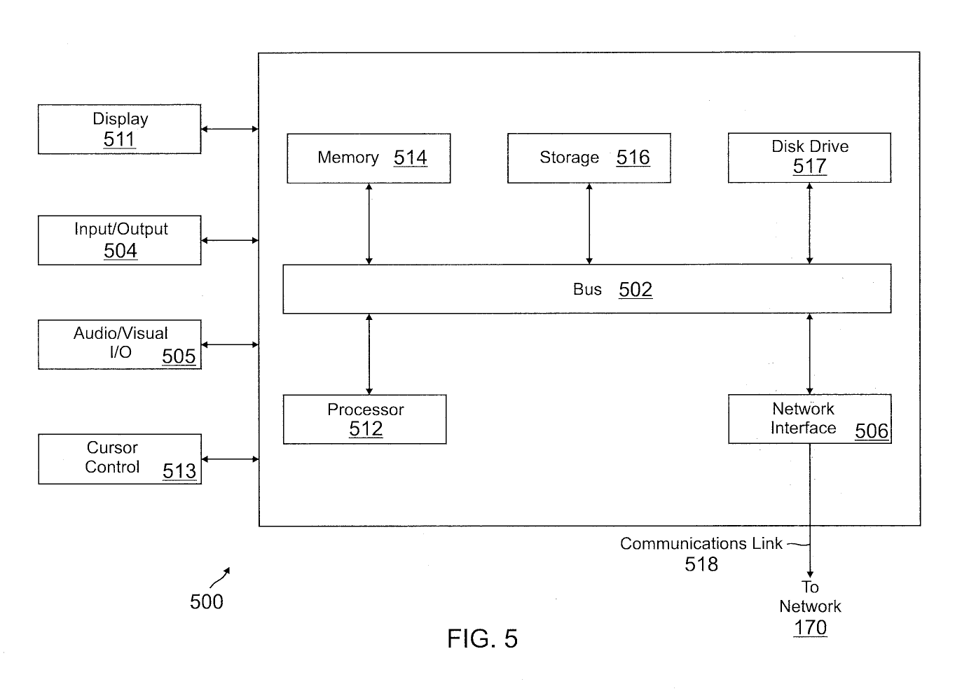

FIG. 5 is a block diagram of a computer system suitable for implementing one or more components in FIG. 1, according to an embodiment. In various embodiments, the user device may comprise a personal computing device (e.g., smart phone, a computing tablet, a personal computer, laptop, a wearable computing device such as glasses or a watch, Bluetooth device, key FOB, badge, etc.) capable of communicating with the network. The service provider may utilize a network computing device (e.g., a network server) capable of communicating with the network. It should be appreciated that each of the devices utilized by users and service providers may be implemented as computer system 500 in a manner as follows.

Computer system 500 includes a bus 502 or other communication mechanism for communicating information data, signals, and information between various components of computer system 500. Components include an input/output (I/O) component 504 that processes a user action, such as selecting keys from a keypad/keyboard, selecting one or more buttons, image, or links, and/or moving one or more images, etc., and sends a corresponding signal to bus 502. I/O component 504 may also include an output component, such as a display 511 and a cursor control 513 (such as a keyboard, keypad, mouse, etc.). An optional audio input/output component 505 may also be included to allow a user to use voice for inputting information by converting audio signals. Audio I/O component 505 may allow the user to hear audio. A transceiver or network interface 506 transmits and receives signals between computer system 500 and other devices, such as another user device, service device, or a service provider server via network 170. In one embodiment, the transmission is wireless, although other transmission mediums and methods may also be suitable. One or more processors 512, which can be a micro-controller, digital signal processor (DSP), or other processing component, processes these various signals, such as for display on computer system 500 or transmission to other devices via a communication link 518. Processor(s) 512 may also control transmission of information, such as cookies or IP addresses, to other devices.

Components of computer system 500 also include a system memory component 514 (e.g., RAM), a static storage component 516 (e.g., ROM), and/or a disk drive 517. Computer system 500 performs specific operations by processor(s) 512 and other components by executing one or more sequences of instructions contained in system memory component 514. Logic may be encoded in a computer readable medium, which may refer to any medium that participates in providing instructions to processor(s) 512 for execution. Such a medium may take many forms, including but not limited to, non-volatile media, volatile media, and transmission media. In various embodiments, non-volatile media includes optical or magnetic disks, volatile media includes dynamic memory, such as system memory component 514, and transmission media includes coaxial cables, copper wire, and fiber optics, including wires that comprise bus 502. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 500. In various other embodiments of the present disclosure, a plurality of computer systems 500 coupled by communication link 518 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A system comprising:
an identity determination module comprising at least one hardware processor that accesses a first transaction request from a first time use of a payment instrument for a first user at a merchant location, accesses a first transaction history for the first user using the payment instrument for the first user, accesses a location of a second user associated with the first user, wherein the second user is associated with the first user based on the first transaction history of the first user and a second transaction history of the second user, and determines a validity of the first transaction request based on the merchant location and the location of the second user, wherein the first transaction request comprises at least the merchant location and the payment instrument for the first user;
a database, stored to a non-transitory memory, that comprises the first transaction request, the first transaction history for the first user, the location of the second user, the second transaction history of the second user, and the validity of the first transaction request; and
a network interface component that receives the first transaction request and the location of the second user and communicates the validity of the first transaction request to a merchant device at the merchant location.

2. The system of claim 1, wherein a communication device of the second user determines the location of the second user using a location module, and wherein the communication device transmits the location of the second user to the network interface component.

3. The system of claim 2, wherein the identity determination module requests the location of the second user from a communication device of the second user.

4. The system of claim 1, wherein the second user permits the location of the second user to be shared in one of a second transaction request for the second user and a completed transaction by the second user, and wherein the network interface component receives the location of the second user with the one of the second transaction request and the completed transaction.

5. The system of claim 4, wherein the one of the second transaction request and the completed transaction is at the merchant location

6. The system of claim 1, wherein the network interface component receives one of a second transaction request for the second user and a completed transaction by the second user as the location of the second user, and wherein the system further comprises:
a transaction processing module that determines the location of the second user using the one of the second transaction request and the completed transaction.

7. The system of claim 1, wherein the merchant device is connected to a wireless beacon using a short range communication protocol to connect with a communication device of the second user to determine the location of the second user, and wherein the merchant device transmits the location of the second user to the network interface component.

8. The system of claim 7, wherein the short range communication protocol comprises one of near field communication, radio communication, infrared communication, Bluetooth communication, Bluetooth Low Energy (BLE) communication, LTE Direct communication, and WiFi communication.

9. The system of claim 1, wherein the validity comprises an identification of the first user at the merchant location if the location of the second user matches the merchant location.

10. The system of claim 9, wherein the transaction request comprises a payment to a merchant associated with the merchant location using the payment instrument, wherein the system further comprises:
a transaction processing module that processes the payment to the merchant using the payment instrument based on the identification of the first user at the merchant location to generate a payment history for the payment to the merchant,
wherein the network interface component communicates the payment history to the merchant.

11. The system of claim 1, wherein the validity comprises a notification that the first transaction request is invalid if the location of the second user does not match the merchant location.

12. The system of claim 1, wherein the validity comprises a notification that the first transaction request is suspicious if the location of the second user does not match the merchant location.

13. The system of claim 12, wherein at least one of the merchant device and a merchant associated with the merchant device request additional identification from the first user for processing of the first transaction request based on the notification.

14. A method comprising:
receiving, by an identity determination module comprising at least one hardware processor, a transaction request from a first time use of a payment instrument for a first user at a merchant location, wherein the first transaction request comprises at least the merchant location and the payment instrument for the first user;
accessing, by the identity determination module, a first transaction history for the first user using the payment instrument for the first user;
accessing, by the identity determination module, a second user location of a second user associated with the first user, wherein the second user is associated with the first user based on the first transaction history of the first user;
determining, by the identity determination module, a validity of the transaction request based on the merchant location and the second user location of the second user.

15. The method of claim 14, wherein the wherein the determining, by the identity determination module, the validity of the transaction request comprises determining the identity of the first user at the merchant location by determining the second user location of the second user matches the merchant location

16. The method of claim 14, wherein prior to receiving, by the identity determination module comprising the at least one hardware processor, the transaction request, the method further comprises:
determining that the second user is associated with the first user using the first transaction history of the first user.

17. The method of claim 14, wherein the first transaction history comprises an identifier for the second user.

18. The method of claim 14, wherein prior to the determining, by the identity determination module, the validity of the transaction request, the method further comprises:
accessing a third user location of a third user associated with the first user, wherein the third user is associated with at least one of the first user and the second user based on at least one of the first transaction history of the first user and a second transaction history of the second user,
wherein the validity is further determined using the third user location.

19. The method of claim 18, wherein the validity comprises a likelihood of fraud score based on the second user location and the third user location matching the merchant location.

20. A non-transitory computer readable medium comprising a plurality of machine-executable modules which when executed by at least one processor of a server are adapted to cause the server to perform a method comprising:
receiving, by an identity determination module comprising at least one hardware processor, a first transaction request from a first time use of a payment instrument for a first user at a merchant location, wherein the first transaction request comprises at least the merchant location and the payment instrument for the first user;
accessing, by the identity determination module, associated users for the first user using the payment instrument for the first user, wherein the associated users comprises a second user;
accessing, by the identity determination module, a location of a second user;
determining, by the identity determination module, a validity of the first transaction request based on the merchant location and the location of the second user.
